(19) United States
(12) Patent Application Publication
(10) Pub. No.: US 2004/0146684 A1
(43) Pub. Date: Jul. 29, 2004

(54) Recording medium and method of manufacturing the same

(75) Inventor: Nobuhisa Yoshida, Kamakura-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/743,552

(22) Filed: Dec. 23, 2003

(30) Foreign Application Priority Data
Dec. 27, 2002 (JP) 2002-382412

(51) Int. Cl. B32B 3/02

(52) U.S. Cl. 428/65.3; 428/694 ST; 427/130

(57) ABSTRACT

The optical disk has the resin material layer provided between the metal layer of the first substrate and the thin layer of the material capable of transmitting light of a predetermined wavelength of the second substrate. The resin material layer has different properties imparted thereto between a location close to the opening and a location away from the opening.

### CROSS-REFERENCE TO RELATED APPLICATIONS

This application is based upon and claims the benefit of priority from the prior Japanese Patent Application No. 2002-382412, filed Dec. 27, 2002, the entire contents of which are incorporated herein by reference.

### BACKGROUND OF THE INVENTION

1. Field of the Invention

The present invention relates to an information recording medium that can record or reproduce information by means of a laser beam, and more specifically to an optical disk formed by adhering two molded substrates together with a UV-hardening resin and a method of manufacturing the disk.

2. Description of the Related Art

There are various types of optical disks, namely a read-only type, typical examples of which are CD and DVD-ROM, a write-once type typical examples of which are CD-R and DVD-R, and a rewritable type, typical examples of which are an external memory for a computer and a recording/playback video disk.

Recently, there is a great demand for an optical disk with an increased capacity, which can deal with a significant increase in recording capacity required in information-related and broadcasting-related devices. Under the circumstances, researches are being made to increase the recording density, more specifically, in order to shorten the wavelength of the laser beam (that is, decreasing the diameter of the spot of the condensed light), to utilize the super-resolution technique, and the like. On the other hand, in order to shorten the track pitch or mark pit pitch, the mastering technique such as electron beam exposure is being studied.

Disks of the DVD standard, which are widely used at present are formed by the following steps. That is, substrates having a thickness of 0.6 mm are prepared by injection-molding a polycarbonate resin. A reflection film and recording film are formed on each molded substrate. A pair of thus prepared substrates are adhered together with use of an ultraviolet ray-hardening resin (to be called UV resin), to have a thickness of 1.2 mm.

Here, in many cases, for example, the spin coat method that uses a spinner is employed to apply the UV resin on a to-be-adhered surface of a disk. However, it is known that the spin coat method entails the following drawback. That is, in the spin coat method, the UV resin is dispersed on the adhering surface of a disk by the centrifugal force. However, at an edge portion (outer circumferential portion) of the disk, the resin film rises due to the surface tension, and thus a UV-resin layer of a uniform thickness cannot be obtained.

For example, Jpn. Pat. Appln. KOKAI Publication No. 11-73691 (Abstract A) already has proposed a solution to the above-described drawback, in its claim 1, FIGS. 3, 4 and 5, page 2, the upper right column, lines 10 to 24. More specifically, in this document, after spinning, a rising portion (outer circumferential portion) is covered with a mask, and the light hardening resin is irradiated with light. In this manner, the other region than the outer circumferential portion is hardened. The hardened outer circumferential resin is removed, and after that, the remaining light-hardening resin is hardened.

In recent years, some disks of the DVD standard are designed for even a larger capacity, in which two molded substrates are adhered together to form DVD (double-layer) disks.

Therefore, it is absolutely necessary that the light emitted from the light source pass through the UV hardening resin layer situated on an inner side of the UV-hardening resin. With this structure, in order to avoid an influence on the intensity of a signal obtained from a recording layer which is located on an inner side, the thickness of the UV resin layer (that is, the thickness of the intermediate layer) of the DVD double-layer disk is defined to 55±10 μm by specification.

Here, it is known that the thickness of the UV hardening resin layer can be made uniform by maintaining a low viscosity of the UV-hardening resin applied by the spinner. At the same time, the resin, in some cases, extends off the center hole, which creates such a drawback that the efficiency of the clamp hole is significantly lowered. In the meantime, if a UV hardening resin portion that extends off onto the surface of the disk, the disk can no longer be practically used and therefore it must be discarded.

On the other hand, when the rotation number of the spinner is increased, bubbles are created in the resin layer. Alternatively, if the location of the UV-hardening resin on the substrate is moved away from the center hole before the rotation of the spinner, the adhesive portion located near the center hole will have only an insufficient adhesion strength, thereby deteriorating the mechanical properties of the disk (clamp hole).

It should be noted that when the mechanical properties of the center hole are deteriorated, the smoothness of the clamp area becomes insufficient, thereby causing unevenness in surface wobbling acceleration, tilted amount and the like in the radial direction of the disk.

Under the circumstance, the object of the present invention is to provide a method of forming a resin layer having a predetermined thickness in a recording medium, and a recording medium manufactured by adhering substrates together with a resin layer, which has an improved adhesion strength at an edge portion of the medium.

### BRIEF SUMMARY OF THE INVENTION

According to an aspect of the present invention, there is provided a method of manufacturing a recording medium, comprising a step of adhering substrates each having a center hole and being able to transmit at least an ultraviolet ray, with each other with use of an ultraviolet hardening resin, wherein two types of resins having different viscosities are used as the ultraviolet hardening resin.

According to another aspect of the present invention, there is provided a recording medium prepared by adhering substrates each having a center hole and being able to transmit at least an ultraviolet ray, with each other with use of an ultraviolet hardening resin, wherein the ultraviolet hardening resin includes two types of resins having different viscosities.

According to still another aspect of the present invention, there is provided a recording medium comprising: a first substrate having an opening of a predetermined diameter at an rotation center thereof, a predetermined pattern transformed around the opening, and a metal layer formed on the predetermined pattern; a second substrate having an opening of a predetermined diameter at an rotation center thereof, a predetermined pattern transformed around the opening, and a thin layer made of a material that can transmit light of a predetermined wavelength, formed on the predetermined pattern; and a resin material layer provided between the metal layer of the first substrate and the thin layer made of the material that can transmit the light of the predetermined wavelength and the second substrate, the resin material layer having different properties imparted thereto between a location closer to the opening and a location away from the opening.

Additional objects and advantages of the invention will be set forth in the description which follows, and in part will be obvious from the description, or may be leaned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic diagram illustrating an optical disk according to an embodiment of the present invention;

FIGS. 2A to 2C are schematic diagrams illustrating steps of manufacturing the optical disk shown in FIG. 1; and

FIGS. 3A to 3C are schematic diagrams illustrating steps of manufacturing the optical disk, which follow those shown in FIGS. 2A to 2C.

### DETAILED DESCRIPTION OF THE INVENTION

Embodiments of the present invention will now be described in detail with reference to accompanying drawings.

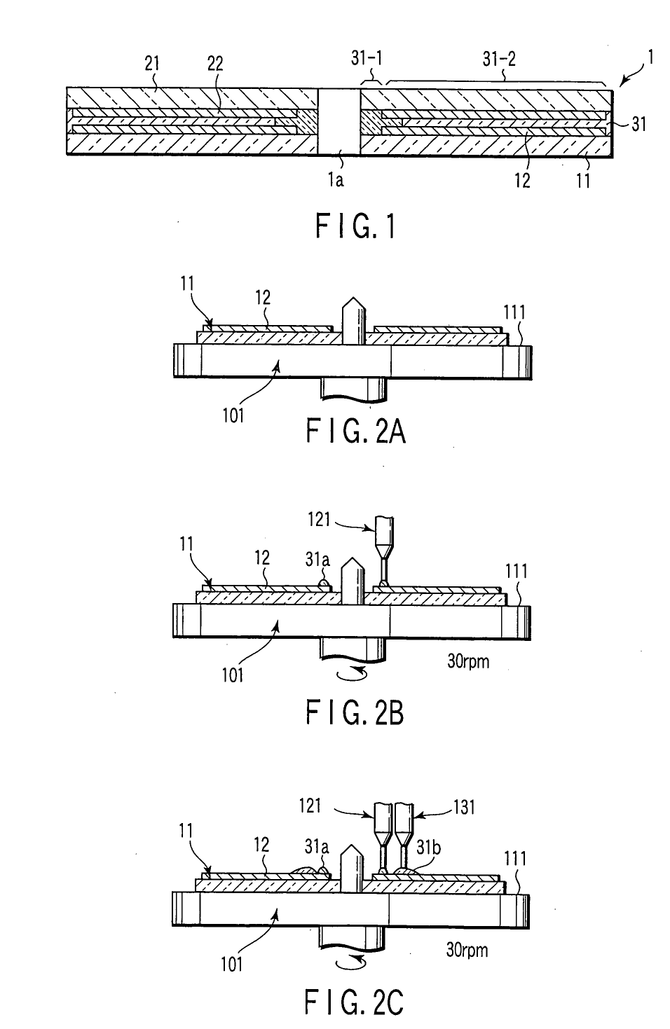

FIG. 1 is a schematic diagram showing an optical disk capable of recording information at a high density, which is prepared by adhering two molded resin substrates together.

As shown in FIG. 1, an optical disk 1 includes a first transparent substrate (lower substrate) 11 and a second substrate (upper substrate) 21 adhered face-to-face onto the first transparent substrate. Between these substrates 11 and 21, a light-hardening resin (to be called UV resin, hereinafter) is applied to have a predetermined thickness. The UV resin hardens when it is irradiated with an ultraviolet ray (to be called UV hereinafter) of a predetermined wavelength, and it makes a hardened UV resin layer 31.

On these substrates 11 and 21, physical information and guiding grooves, which are not shown in the figure, are formed in advance. These information and grooves are utilized in recording or reproduction of information by a recording/playback device. Further, thin layers made of a metal material, which can be used as recording layers namely, that is, recording layers 12 and 12, are formed on the substrates, respectively. Further, on these two substrates 11 and 21, a metal-made thin layer that can be used as a reflection layer, an interlayer protection layer, a cover layer or the like may be formed.

The UV resin layer 31 is formed such that it is directly in contact with both of the lower substrate 11 and upper substrate 21 in a first region 31-1, which are adhered together. The first region 31-1 is defined at a section beside the center hole 1a of the optical disk 1 and on a further inner side of the recording layers 12 and 22. In other words, in the first region 31-1, the substrates 11 and 12 are adhered together without interposing the metal-made thin films between them, but only with the UV resin layer 31. This structure is effective for improving the strength of the center hole 1a.

On the other hand, in a region 31-2 of the UV resin layer 31 defined mostly between the recording layers 12 and 22 (including its outer circumferential portion), the disk has a uniform thickness in its radial direction.

FIGS. 2A to 2C are schematic diagrams showing a method of manufacturing the optical disk shown in FIG. 1 and the steps in the method.

First, as shown in FIG. 2A, the lower substrate 11 is set on a disk retention table 111 of a spinner 101. Note that although not shown in the figure, the lower substrate 11 has pits (physical information) and lands/grooves (guiding grooves) transferred in advance by a stamper. The transfer surface of the substrate is coated with a total reflection metal thin film such as an Al film to have a predetermined thickness.

Next, as shown in FIG. 2B, a predetermined amount of the UV hardening resin is supplied from a first nozzle 121 of the spinner 101. From the first nozzle 121, a first resin 31a having a high viscosity is supplied. Here, the disk retainer table 111 of the spinner 101 is rotated at a rate of about 30 rpm by means of a motor, which is not shown in the figure. The viscosity of the first resin is, for example, about 5,000 CPS; however, the viscosity can be selected arbitrarily from about 500 to 10,000 CPS in accordance with the combination of the rotation speed of the disk retainer table 111 and the viscosity of the second resin, which will be described below.

The first resin 31a output from the first nozzle 121 is supplied to a region (the first region 31-1) defined between the innermost radius of the lower substrate 11(, which is the outermost radius of the center hole 1a of the optical disk 1) and the recording layer 12, in an amount equivalent to at least one round of the lower substrate 11 (optical disk 1). It should be noted that the first nozzle 121 is situated at a position about 21 mm from the center when manufacturing, for example, DVD standard disk (, which has an outer diameter of 120 mm). With this structure, it is possible to prevent the leakage of the resin to the center hole 1a while setting the upper substrate 21.

Next, as shown in FIG. 2C, the second resin 31b, which has a lower viscosity such as about ⅓ to ⅕ of that of the first resin, is supplied from the second nozzle 131 onto a region near the inner circumferential edge of the recording layer 12 of the lower substrate 11, and slightly outer side to the region to which the first resin 31a has been supplied as shown in FIG. 2B. The disk retainer table 111 is rotated at about 30 rpm. The viscosity of the second resin is, for example, about 400 CPS; however, the viscosity can be selected arbitrarily from about 100 to 1,000 CPS in accordance with the combination of the rotation speed of the disk retainer table 111 and the viscosity of the first resin 31a, which will be described below.

It should be noted that the second nozzle 131 is situated at a position about 23 mm from the center when manufacturing, for example, DVD standard disk. Further, the second resin 31b is supplied in an amount corresponding to at least one round of the lower substrate 11 (the optical disk 1) so as not to generate any bubbles between the lower substrate 11 and the first resin 31a. In this manner, even if the first resin 31a and the second resin 31b are mixed together, such mixing will not make any problem.

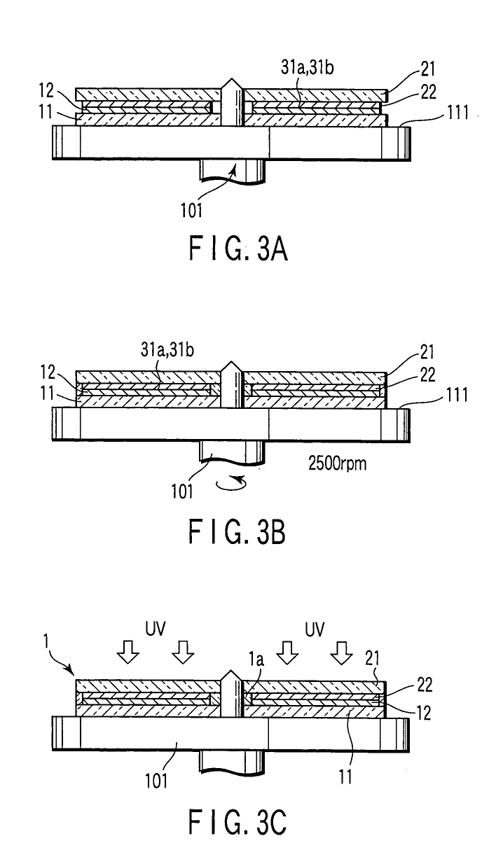

Subsequently, as shown in FIG. 3A, the upper substrate 21 is set on the lower substrate 11 on which the first and second resins 31a and 31b have been supplied. The substrates are set such that the innermost radiuses of these (, which are the portions that define the outermost circumference of the center hole 1a of the optical disk 1,) coincide with each other. In this case, it is only natural that the recording surface 22 of the upper substrate 21 is directed towards the first and second resins 31a and 31b. With this structure, the weight of the upper substrate 21 is loaded on the UV resin layer 31. However, the resin having a high viscosity is provided in a section closer to the center hole, it is possible to prevent the leakage of the resin from the center hole. Note that although not shown in the figure, the upper substrate 21 has pits (physical information) and lands/grooves (guiding grooves) transferred in advance by a stamper. The transfer surface of the substrate is coated with a semi-transmission metal film such as an Au or Ag film to have a predetermined thickness.

Next, as shown in FIG. 3B, the disk retainer table 111 is rotated at an off-scale rotation speed of, for example, 2,500 rpm, and thus the excessive portion of the UV resin supplied between the substrates 11 and 21 is thrown off to the outside. In this manner, the UV resin 31 (layers 31a and 31b) thus supplied is formed to have a predetermined thickness without crating bubbles inside, and it is made even respectively in the first and second regions.

Subsequently, as shown in FIG. 3C, UV light of a predetermined wavelength is applied from a UV irradiation device, which is not shown in the figure, and thus the optical disk 1 explained before with reference to FIG. 1 is formed.

In the optical disk 1 thus formed, the thickness of the UV resin layer is constant, and the clamp area is completely filled with the resin. Further, the resin is hardened in a range of a larger diameter that that of the center hole made in the first and second substrates. Therefore, the tilt property of the disk can be improved. Further, since the UV resin 31 is stuffed uniformly between the substrates 11 and 21, the variation of the disk with time becomes less, thereby extending the lifetime of the disk.

The viscosity of the UV resin layer 31 employed in the optical disk 1 shown in FIG. 1 can be easily analyzed from wavelength data obtained by, for example, an X-ray photoelectron spectroscopy or infrared spectroscopy with use of a sample taken at a radial position of the optical disk 1 after hardening.

The thickness of the UV layer of a prototype optical disk A manufactured by the above-described method was examined with a Dr. Schenk measuring machine. As a reference, a disk B was manufactured with only one type of low viscosity resin, and the disks A and B were compared in terms of the thickness of the UV layer from the inner radius to the outer radius. The results were as shown in TABLE 1 below.

| | | Radial (mm) | | | |
|---|---|---|---|---|---|
| | | 23 | 34 | 45 | 56 |
| Disk A | Thickness (nm) | 26.4 | 25.6 | 26.7 | 27.5 |
| | Displacement (nm) | 2.4 | 1.2 | 0.9 | 2.1 |
| Disk B | Thickness (nm) | 23.2 | 25.4 | 26.7 | 28.8 |
| | Displacement (nm) | 4.2 | 2.6 | 0.8 | 1.2 |

As is clear from TABLE 1, in the disk B, the thickness of the UV layer gradually increases from an inner radius towards an outer radius, whereas in the disk A, the difference in the thickness of the UV layer from one radial position to another is very small.

Further, the variations (displacement/deviation) in the thickness of the UV layer within one round of the disk are suppressed to a low level in the disk A especially in its inner radius portion.

| | | | Radial (mm) | | |
|---|---|---|---|---|---|
| | | | 24 | 35 | 57 |
| Disk A | Radially | Max | 0.04 | −0.11 | −0.21 |
| | | Min | −0.08 | −0.23 | −0.32 |
| | Tangentially | Max | 0.07 | 0.04 | 0.08 |
| | | Min | −0.06 | −0.06 | −0.07 |
| Disk B | Radially | Max | −0.02 | −0.14 | −0.31 |
| | | Min | −0.21 | −0.33 | −0.45 |
| | Tangentially | Max | 0.13 | 0.12 | 0.13 |
| | | Min | −0.11 | −0.09 | −0.09 |

(angle α: °)

As is clear from TABLE 2, the disk A is less tilted both radially (radial direction) and tangentially (normal to radial direction) as compared to the case of the disk B. In particular, the variations in tilting in one round of the disk A in an inner radius portion can be suppressed to about one half of the case of disk B.

In the recording/reproduction method of a constant linear speed, it is more difficult to carry out a servo control for focusing/tracking in an inner radius portion than in outer radius portion, because the rotation speed becomes higher in the inner radius portion. The results obtained here indicate that the disk A has an advantageous effect of achieving stable recording/reproduction.

It should be noted that the UV-hardening resin used in the present invention is of an acryl-based type in which the hardening progresses by radical polymerization; however as long as the viscosity of the resin satisfies the condition, a cation-polymerization type epoxy resin can be used without any problem.

Further, the above-described embodiment was described in connection with the case where substrates both having a thickness of 0.6 mm are adhered together. However, it is only natural that with the present invention, the same advantages can be obtained in the case where, for example, a cover layer having a thickness of 0.1 mm is adhered onto a substrate having a thickness of 1.1 mm.

It should be pointed out that the present invention is not limited to the above-described embodiment, but it can be remodeled or revised into various versions when it is actually carried out as long as the essence of the invention remains within its scope. Various embodiments can be combined together as needed, and in that case, an advantage achieved by the combination can be obtained.

Further, the combination of a low-viscosity resin and a high-viscosity resin can be arbitrarily selected from the above-mentioned ranges in consideration of the rotation speed of the table of the spinner.

For example, the following are some of the combinations of the high-viscosity resin and low-viscosity resin along with the rotation speed of the table when both of these resins are of an acryl-based type. The combinations are expressed by a list of a) viscosity of high-viscosity resin (cps), b) viscosity of low-viscosity resin (cps) and c) table rotation speed of off-scale rotation (rpm):

1) a) 5000, b) 1000, c) 6000;

2) a) 3000, b) 500, c) 2500; and

2) a) 5000, b) 250, c) 2000.

With these combinations, it is possible to obtain optical disks each having a resin layer of a substantially uniform thickness from the vicinity of the center hole to the edge of the disk, and thereby having stable optical properties.

Further, it is possible to reduce the number of disks, which easily passed the condition of the mechanical strength of the center hole, becoming unusable only because the resin extends off from the inner side of the center hole.

Furthermore, with these combinations, bubbles that may be mixed into the resin layer from the center hole of the substrates can be shut off while rotating the spinner, thereby assuring an even clamp area. Therefore, the reproduction of information can be stably carried out. In addition, the quality of the appearance of the disk can be improved.

It is also possible to prevent the resin from leaking from the center hole when the upper substrate is set.

The thickness of the UV layer can be made uniform from an inner radius portion over to an outer radius portion.

Since the thickness of the UV layer becomes constant and the clamp area located in the inner radius portion is sufficiently filled with the resin, the tilting property of the disk can be improved.

Since the UV resin is filled evenly between the substrates, the variation of the disk with time can be suppressed, thereby prolonging the lifetime of the disk.

As described above in detail, according to the present invention, there is provided a recording medium having stable optical properties in the form of a disk. In the invention, the disk is manufactured by adhering a lower substrate and an upper substrate together such that the thickness of the resin layer is substantially uniform from the vicinity of the center hole to the edge portion of the disk.

Further, with the present invention, it is possible to reduce the number of defective disks created by the resin portion extending off from the inner side of the center hole while easily assuring the mechanical strength of the center hole. Therefore, the yield of the product can be improved.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method of manufacturing a recording medium, comprising a step of adhering substrates each having a center hole and being able to transmit at least an ultraviolet ray, with each other with use of an ultraviolet hardening resin, wherein two types of resins having different viscosities are used for the ultraviolet hardening resin.

2. The recording medium manufacturing method according to claim 1, wherein the two types of ultraviolet hardening resin are a high-viscosity resin having a viscosity of 500 CPS to 20,000 CPS and a low-viscosity resin having a viscosity of 50 CPS to 1,000 CPS.

3. The recording medium manufacturing method according to claim 2, wherein a location where the high-viscosity resin is dropped is closer to the center hole than a location where the low-viscosity resin is dropped.

4. The recording medium manufacturing method according to claim 2, wherein the high-viscosity resin and the low-viscosity resin are hardened after both of them are diffused to have a predetermined thickness.

5. The recording medium manufacturing method according to claim 3, wherein the high-viscosity resin and the low-viscosity resin are hardened after both of them are diffused to have a predetermined thickness.

6. A recording medium prepared by adhering substrates each having a center hole and being able to transmit at least an ultraviolet ray, with each other with use of an ultraviolet hardening resin, wherein the ultraviolet hardening resin includes two types of resins having different viscosities.

7. The recording medium according to claim 6, wherein the two types of ultraviolet hardening resin are a high-viscosity resin having a viscosity of 500 CPS to 20,000 CPS and a low-viscosity resin having a viscosity of 50 CPS to 1,000 CPS.

8. The recording medium according to claim 7, wherein the high-viscosity resin is placed at an inner location with respect to the center hole and the low-viscosity resin is placed at an outer location thereto.

9. A recording medium comprising:
a first substrate having an opening of a predetermined diameter at a rotation center thereof, a predetermined pattern transformed around the opening, and a metal layer formed on the predetermined pattern;
a second substrate having an opening of a predetermined diameter at an rotation center thereof, a predetermined pattern transformed around the opening, and a thin layer made of a material that can transmit light of a predetermined wavelength, formed on the predetermined pattern; and
a resin material layer provided between the metal layer of the first substrate and the thin layer made of the material that can transmit the light of the predetermined wavelength and the second substrate, the resin material layer having different properties imparted thereto between a location closer to the opening and a location away from the opening.

10. The recording medium according to claim 9, wherein the different properties are in viscosity and the viscosity is higher in a location close to the center hole.
